(19) United States
(12) Patent Application Publication
(10) Pub. No.: US 2008/0236513 A1
(43) Pub. Date: Oct. 2, 2008

(54) Animal Control Device

(76) Inventors: Ingrid Barlebo-Larsen, Surrey (GB); Jane Louise Potter, Chertsey (GB)

Correspondence Address: SHEMWELL MAHAMEDI LLP, 4880 STEVENS CREEK BOULEVARD, SUITE 201, SAN JOSE, CA, 95129, US

(21) Appl. No.: 11/575,208

(22) PCT Filed: Aug. 31, 2005
(86) PCT No.: PCT/GB2005/003367

§ 371 Date: Jun. 6, 2008

(30) Foreign Application Priority Data
Sep. 13, 2004 (GB) 0420342.8

(51) Int. Cl. A01K 15/02; A01K 27/00

(52) U.S. Cl. 119/719; 119/720; 119/858; 119/859

(57) ABSTRACT

A control device (1) for a domesticated animal comprises a mechanism (12, 13, 14) for producing a sensation disconcerting to a domesticated animal. A timer (24) is operative to cause the mechanism to produce the disconcerting sensation after a predetermined time period. The control device is configured such that it may be carried by said domesticated animal without undue interference with said animal's freedom of movement.

### FIELD OF THE INVENTION

The present invention relates to a device for controlling a domesticated animal. In particular, but not exclusively, the invention relates to a control device for a dog.

### BACKGROUND

There are many known devices for controlling domesticated animals, in particular for controlling dogs. One example is the well known “dog whistle” which can be used to emit whistles of different pitch by which a user is able to give instructions to a dog. The different pitches correspond to different instructions. The pitch may be such that the whistle is audible to a human or just to a dog. Such whistles are commonplace when using dogs to control livestock, for example a shepherd using a sheepdog. However, a dog must be trained to respond as required to such a whistle, and not all breeds of dog are susceptible to training. Furthermore, to be effective the whistle must be capable of being heard by the dog, which may not be the case in inclement weather or if the dog is a long way away from the whistle, or there are trees or buildings which obstruct the sound travelling to the dog. Another problem concerns dogs whose hunting instinct is so great that they ignore and do not respond to sonic signals such as whistles.

Other devices are available for controlling, inhibiting or stopping anti-social or errant behaviour by dogs. Such devices generally require little or no training of the dog to have an effect. One example of such a device consists of a number of plastic or metal discs on a ring which when shaken or thrown to the ground, particularly in front of the misbehaving dog, makes an unpleasant sound causing the dog to interrupt their behaviour. With practice, and some training, a dog can be encouraged to stop whatever they are doing when the discs are used. However, the user (who is likely to be the person walking the dog such as an owner or carer) must be sufficiently close to the dog (e.g. within a few metres) in order use the discs effectively.

An example of errant behaviour is that of a dog running off from its carer when released from its lead, and of failing or refusing to return to the carer. This can be extremely distressing, and time-consuming, for the carer. Very often, a carer of a dog that has proven unresponsive to recall training resorts to keeping their dog on a lead. This can be very unsatisfying for the carer, and dog, and in extreme circumstances can lead to a dog having insufficient exercise causing ill-health and destructive behaviour, and in some cases carers feel obliged to have their dogs destroyed.

A device which is used to attempt to control or stop a dog running off is known. The device is called PRODOG TRAINER available from Radio Systems Corp., 10427 Electric Avenue, Knoxville, Tenn. 37932 USA. The PRODOG TRAINER consists of electrodes which are attached to the dog and are connected to a store of electrical charge such as a battery, and a user remote control unit. The user can operate the remote control to cause an electric shock to be delivered to the dog. These devices are intended to remotely control a dog to keep within a distance of the user the user finds comfortable. If the dog is wandering to far away, then an electric shock is delivered to it. After time the dog learns not to wander to far from the user of the device. A drawback of this system is that the remote control has a limited range (e.g. about 100 metres), and should the dog move beyond that range then the system does not work. Additionally, because the remote control is battery operated its effective range reduces as the battery runs down, and consequently it is difficult for a user to accurately predict the effective range of the remote control. Also, the battery in the electrode device runs down, and so the shock that is delivered to the dog is reduced over time, and may deliver ineffective electric shocks without the users knowledge.

In general, known devices for controlling dogs require training of the dog. Those devices which require little or no training need the user to be alert to the activities of their dog at all times, and for the dog to be close by or within range of a radio remote control. Furthermore, the effectiveness of many devices is reduced if there are obstructions such hillocks, trees and buildings, and therefore may preclude exercising a dog in areas where such obstructions exist, for example in woodland or sand dunes.

Embodiments of the present invention were devised with the foregoing problems in mind.

### SUMMARY

Viewed from one aspect the present invention provides a control device for a domesticated animal, comprising a mechanism for producing a sensation disconcerting to a domesticated animal, and a timer operative to cause said mechanism to produce said disconcerting sensation after a predetermined time period. The disconcerting sensation may be one or more of uncomfortable, irritating or worrying to the animal for example. The control device is self-contained and configured such that it may be carried by a domesticated animal without undue interference with the animal's freedom of movement. Such a control device is independent of user since once the timer is set the user does not need to do anything further. Since the control device is self-contained and does not need remote activation there are no problems with remote activation signals being blocked by barriers such as trees and hillock. Additionally, the device allows the animal to roam free for a predetermined time without any monitoring by the user, leaving the user free to do other things. Furthermore, the sensation is not intended to be painful or harmful to the animal.

The device is releasably attachable to the domesticated animal to allow for cleaning of the device and to maintain hygiene, and also for the animals comfort when the device is not in use. The control device may itself comprise means for releasably attaching the control device to a domesticated animal.

Simply, the device may be attached by, or comprise, a lanyard for placing around a body part of the domesticated animal. Optionally the lanyard may comprise a pouch for enclosing the device. In such an arrangement, the control device can simply be placed in the pouch and does not need any other forms of attachments.

Since many domesticated animals have collars or harnesses, the control device is conveniently configured to be releasably attachable to a collar or harness.

It is desirable for the timer to be configurable by a user to set the predetermined time period after which the mechanism is active to produce the disconcerting sensation, so that a user can determine how long the animal is to be allowed to roam. It is also useful for a user to be able to gradually increase the time period before the mechanism is activated as part of training the animal to return to the user when it experiences the disconcerting sensation. Initially, the timer may be set for a very short period of time so that the animal is close enough to the user to be encouraged to return to the user for the sensation to be switched off. After time, the animal will realise that returning to the user will result in the disconcerting sensation stopping. Therefore, the time period before the mechanism is activated can be increased with a reasonable degree of certainty that the animal will return to the user when the disconcerting sensation is active.

The disconcerting sensation may be produced intermittently, which avoids the animal becoming accustomed to the sensation and ignoring it, as well as reducing the likelihood of the animal becoming unduly distressed by a continuous sensation. Advantageously, the timer is configurable by a user to cause the mechanism to produce the disconcerting sensation at predetermined intervals, which allows the user to adapt the sensation to its own animal's sensitivities and responsiveness to the device. In a particular embodiment the timer user is configurable with a second time period to set the predetermined intervals thereby providing the user with another parameter that can be varied to adapt the device to an individual animal.

A convenient disconcerting sensation is one audible only to animals and not humans in order that operation of the device does not disturb other people. However, if the sound is audible to a human then it will assist the user in locating the animal. This is particularly useful during training of the animal when it may not reliably return to the user.

Optionally, or additionally, the disconcerting sensation may comprise a haptic sensation, in particular a vibration, which is silent therefore non-disturbing to others. A vibration sensation is particularly suitable as vibration units are readily available.

Optionally, or additionally, the disconcerting sensation comprises a visible light, which would also help a user to locate their animal, particularly in poor light.

Suitably, the mechanism is operable to provide variations in the disconcerting sensation, which can increase the disconcerting effect, can reduce the likelihood of distress and avoid the sensation becoming familiar to and tolerable for the animal. For example, in one embodiment the mechanism is operable to increase the intensity of the disconcerting sensation over time from initiation by the timer, which can reduce and avoid distress for the animal and encourage prompt response to the sensation by the animal.

For safety, the mechanism is operable to cap said intensity at a predetermined level to avoid overly distressing or injuring the animal. Optionally, or additionally, the mechanism is operable to produce said disconcerting sensation for a limited time period which is particularly useful as it avoids distressing the animal if unable to return to owner for some reason, for example it is caught in a bush.

Given that animals go outside in all weathers the device is made waterproof, and preferably sufficiently waterproof so that the animal can go into water without damaging the device. Also the device is made shockproof and is in a rugged housing, to cope with energetic of clumsy animals. One example of a rugged housing is a rubberised housing.

A suitable embodiment is a collar or harness for a domesticated animal, comprising a control device as described above integrated therewith.

In particular the control device is configured for a dog, since it is particularly suitable for dogs as they tend to respond to disconcerting sensations by finding their owner if disconcerted or distressed.

### BRIEF DESCRIPTION OF THE DRAWINGS

FIG. 1 schematically illustrates a control device in accordance with an embodiment of the present invention held in a pouch.

FIG. 2 schematically illustrates the arrangement of FIG. 1 in use.

FIG. 3 schematically illustrates another arrangement for a control device in accordance with an embodiment of the present invention.

FIG. 4 schematically illustrates the arrangement of FIG. 3 in use.

FIG. 5 is a schematic illustration of circuitry for implementing an embodiment of the present invention.

FIG. 6 is a flow control diagram for a first embodiment of the present invention; and

FIG. 7 is a flow control diagram for a second embodiment of the present invention.

### DESCRIPTION OF EMBODIMENTS OF THE INVENTION

Embodiments of the present invention will now be described, with reference to the accompanying drawings briefly described above, by way of example only. The following description will use a dog as an example of a domesticated animal, however embodiments of the present invention may be used with other domesticated animals.

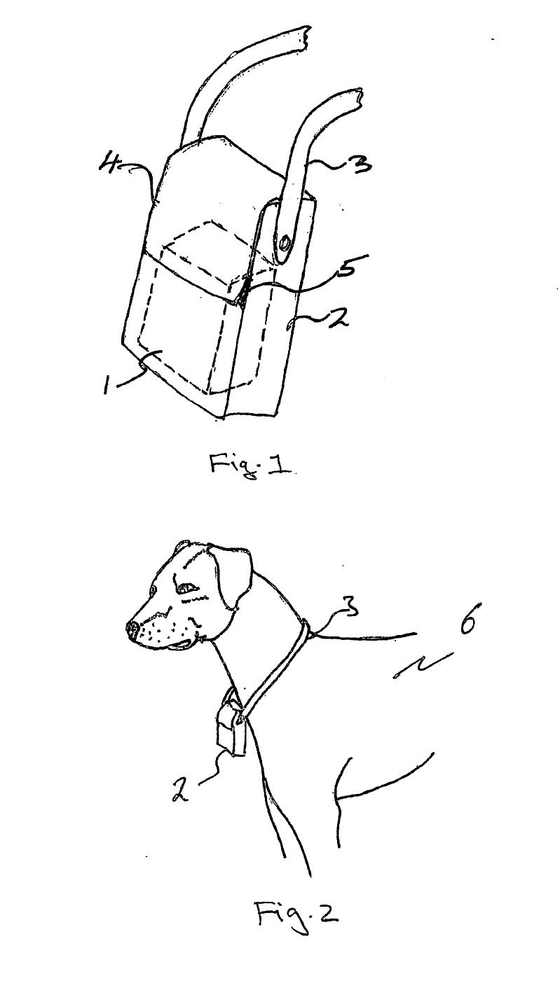

To be effective, an animal control device in accordance with an embodiment of the present invention must be attached to the dog in some way. FIG. 1 illustrates a control device 1 placed in a pouch 2. The pouch 2 has a strap 3, and a cover 4 removably attachable to the pouch 2 by a fastener 5 such as Velcro®. Other fasteners may be used such as a press-stud or belt and buckle fastener. The control device 1 is placed in the pouch 2 and the cover 4 fastened in place to stop the control device 1 inadvertently falling out of the pouch 2.

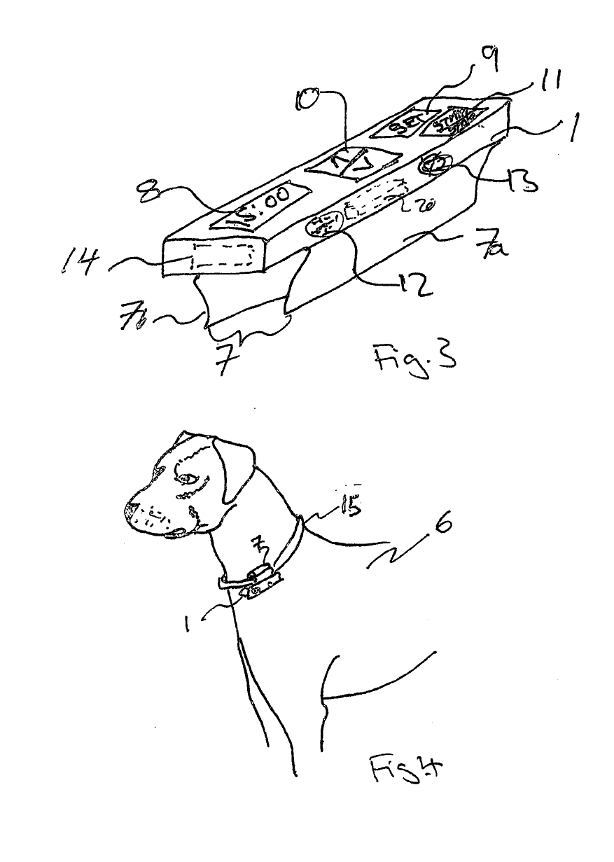

FIG. 2 illustrates the device in use. The strap 3 of the arrangement illustrated in FIG. 1 is placed around the neck of a dog 6. The dog 6 is able to move freely with the control device 1 attached to it.

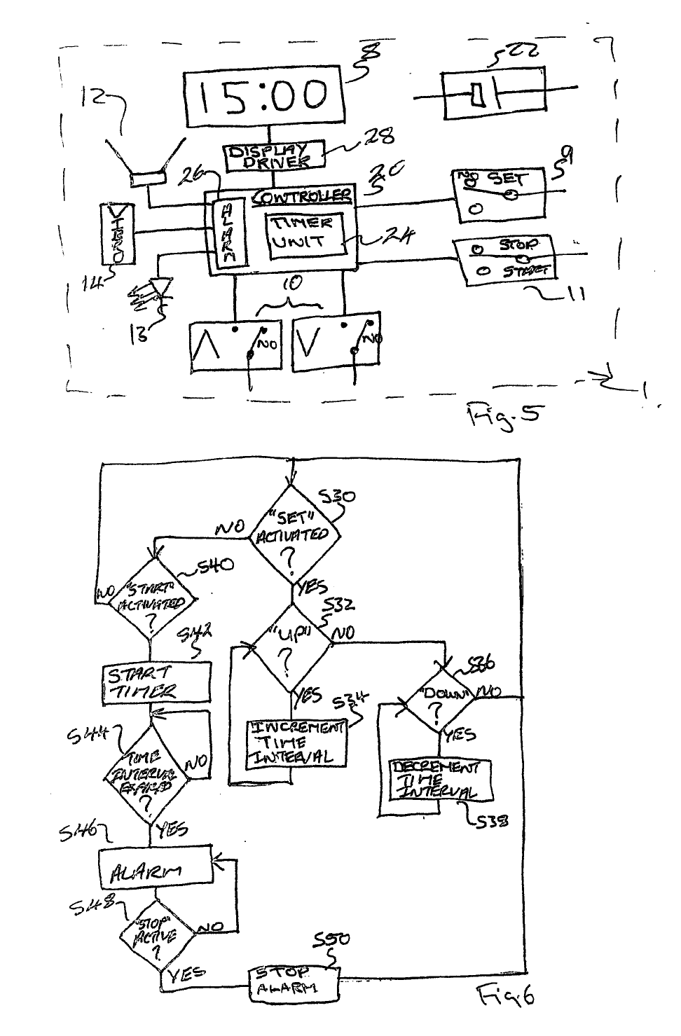

FIG. 3 is a more detailed illustration of the control device 1, and also shows an alternative arrangement 7 for attaching the control device 1 to a dog 6. The attachment arrangement 7 consists of two strips of flexible material 7a, 7b, with suitable fastening means such as Velcro® used to fasten the two strips 7a and 7b together. As illustrated in FIG. 4, the two strips may be fastened together to form an attachment arrangement 7 around the collar 15 of a dog 6 thereby attaching the control device 1 to the dog 6.

FIG. 3 schematically illustrates the main components of the control device 1. User interface devices include a LCD 8 for displaying the timer settings. A controller 20 is configured to receive user input control signals from various user control input buttons. For example, SET button 9 for initiating a set-up mode of the control device 1; UP/DOWN buttons 10 for inputting signals to increase or decrease a time or time interval during the set-up mode; and START/STOP buttons 11 for starting and stopping the timer of the control device 1. The control device 1 also includes one or more of: a loudspeaker 12 for generating an audible alarm; an LED 13 for generating a visual alarm; and a vibrator 14 for generating a vibrating alarm. The controller 20 controls the alarm devices in accordance with the timer information input to the controller 20 via the various input devices 9, 10 and 11.

An example of circuitry for an implementation of an embodiment of the present invention is illustrated in FIG. 5. A controller 20 receives power from a battery 22. The controller 20 includes a timer unit 24 and an alarm module 26. The controller 20 also provides signals to display driver 28, which in turn supplies drive signals to LCD 8. The SET button 9 is a single pole single throw push-button normally open switch which when activated sends a signal pulse to the controller 20 which causes the controller to enter a set-up mode. The UP/DOWN buttons 10 are also single pole single throw push-button normally open switches, and in the set-up mode activation of the UP or DOWN button sends a signal to the timer unit 24 to increase or decrease a time interval. START/STOP button 11 is also single pole single throw push-button, activation of which causes the controller 20 to toggle between starting and stopping timer unit 24. In set-up mode controller 20 sends signals to display driver 28 to display on LCD 8 the time interval selected by the user using the UP/DOWN buttons 10.

When the START/STOP button 11 is activated the timer unit 24 starts its timer and either counts up to the time input to the controller, or counts down from that time. Once the input time interval has expired the timer unit 24 sends a time-out signal to alarm module 26 which activates one or more of the audible 12, visual 13 or vibrating 14 alarm.

In one embodiment controller 20 is a general-purpose microprocessor. Each of timer unit 24, alarm module 26 and the signals to display driver 28 are implemented by way of software routines. However, it will be evident to the person of ordinary skill in the art that embodiments of the present invention may be implemented by way of software, firmware, hardware or a combination of any two or more thereof.

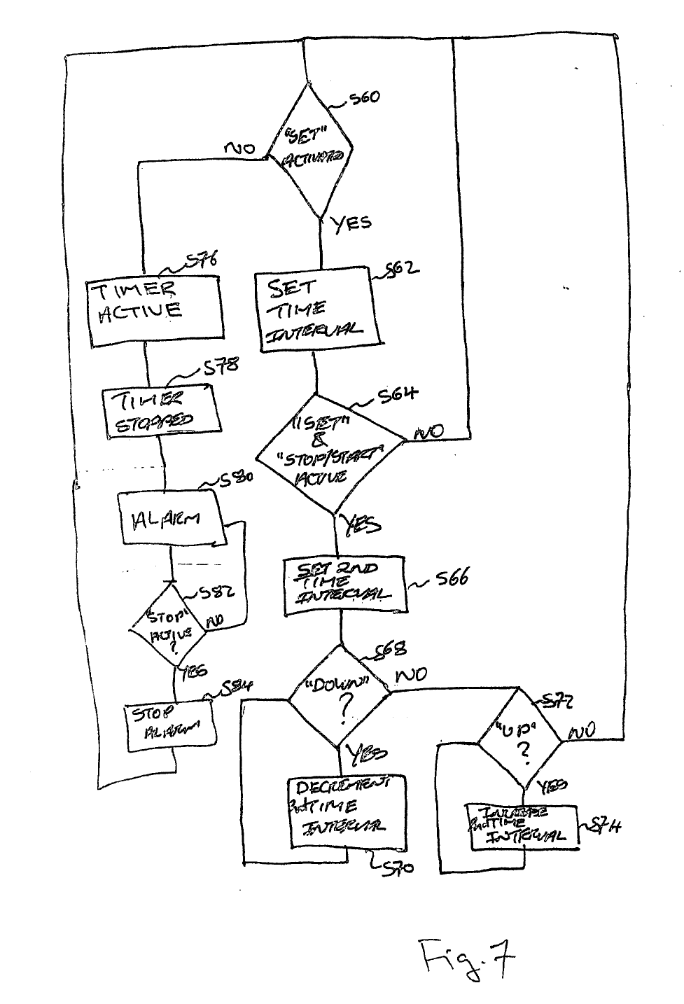

Referring now to FIG. 6, the process flow for a first embodiment of the present invention implemented by way of a microprocessor controller will be described. The process starts at S30 where the controller waits for a signal indicating that the SET button has been activated. If the SET button has been activated the process flows to step S32 where it is determined if an UP signal is present corresponding to the UP button being pressed. If yes, then the process goes to step S34 where the time interval between the start and stop of the timer is increased by a predetermined amount, for example 1 minute, two minutes or five minutes. Process flow returns to S32 where it is again determined whether or not an UP signal is present. As before, if an UP signal is present the process goes to step S34.

If no UP signal is present as step S32 then the process flow goes to step S36 in which it is determined if a DOWN signal is present, corresponding to activation of the DOWN button. If yes, then the process goes to step S38 where the time interval between the start and stop of the timer is decreased by a predetermined amount, for example 1 minute, two minutes or five minutes. Process flow returns to S36 where it is again determined whether or not a DOWN signal is present. As before, if a DOWN signal is present the process goes to step S38.

If no DOWN signal is present at step S36 the process flow returns to step S30 where it is determined if the SET signal is present. If yes, then process flow proceeds to S32. If no SET signal is present at step S30, then the process flows to step S40 where it is determined whether or not a START signal is present corresponding to activation of the START button. If no START signal is present at step S40 the process flow returns to step S30.

If a START signal is present at step S40 then the timer unit 24 is started at step S42 and expiry of the interval monitored at step S44. Once the time interval has expired then process control flows to step S46 when the alarm module 26 is activated. The process then flows to step S48 which monitors for a STOP signal corresponding to activation of the STOP button. If no STOP signal is present at S48 then the alarm continues. Once activation of the STOP button occurs and the STOP signal is detected at S48 the alarm is stopped at step S50 and process control flow returns to step S30.

The process control for a second embodiment of the present invention is iu in the flow diagram of FIG. 7. The second embodiment is slightly more sophisticated than the first embodiment in that it allows a user to set the alarm to go off at second time intervals. The length of time the alarm remains on between intervals can be “factory” pre-set or may be programmed by a user.

Referring now to FIG. 7, process control starts at step S60 where the controller 20 waits for a SET signal. Once a SET signal has been detected, the process flows to step S62 at which the time interval before the alarm is activated is set. The process flow for this part of the flow diagram is the same as for steps S32 to S38 in the flow diagram of FIG. 6 and so will not be described again in detail. Once that time interval has been set, then the process flows to step S64 where it determines if both a SET and a START/STOP signal are present, i.e. the user is pressing both SET and START/STOP buttons simultaneously. If both signals are present then the controller initiates a routine for setting the second time interval, step S66.

Once the routine for setting the second time interval has been initiated the process flows to step S68, where if a DOWN signal is present the time interval is decreased, step S70, and if not then the process flows to step S72. At step S72 it is determined if an UP signal is present, and if so then the second time interval is increased, step S74. If no UP signal is present then the process flow returns to step S60.

At step S60 if no SET signal is detected the process flows to step S76 where the timer unit 24 is activated. The timer operates in accordance with steps S42 to S46 of FIG. 6, and stops at step S78. the alarm is activated at step S80 and is intermittently operative at time intervals conforming to the second time interval set by the user. At step S82 the controller 20 monitors for a STOP signal and if detected the alarm is stopped at step S84. The process flow then returns to step S60.

There has now been described in detail apparatus, control circuitry and methods of operation for two embodiments of the invention. In view of the foregoing description of particular embodiments of the invention it will be appreciated by a person skilled in the art that various additions, modifications and alternatives thereto may be envisaged. For example, the alarm may be made to vary in pitch, amplitude or intensity, in particular gradually increasing over time to increase the disconcerting sensation for the dog. The pitch, amplitude or intensity is capped so that it will not increase to a level which causes undue stress, pain or injury to the dog.

In a particular embodiment the device operates in a similar manner to a digital stopwatch or alarm clock. A period may be set for the device, for example 15 minutes, to emit an alarm. After the time period has elapsed the alarm will be activated an produce a vibration and ascending beeping noise. The beeping noise will increase in intensity or volume tolerable to a human in order to ensure that it is audible to the human carer, but not painful to the animal to which the device is attached. Suitable audible alarms are available such as used for alarm clocks, and the vibration may be supplied by a unit similar to those used in mobile telephones. Suitably, the device is made of a light material such as a plastics and is robust, relatively shock-proof and moisture-proof. the controls of the device are stiff so that they cannot be moved inadvertently. Optionally, the device controls may be “locked-out” so that they are inactive until made active by a particular sequence of control actions or button presses. The device is attachable to the animal by cords, strings or straps which may be made of a similar material to a dog lead.

Insofar as embodiments of the invention described above are implementable, at least in part, using a programmable data processing apparatus, it will be appreciated that a computer program for implementing at least part of the described apparatus and/or methods, is envisaged as an aspect of the present invention. The data processing apparatus may be any suitable apparatus or device. For example, the data processing apparatus may be a general purpose microcontroller or a microprocessor. The computer program may be embodied as source code and undergo compilation for implementation on a computer, or may be embodied as object code, for example.

Suitably, the computer program can be stored on a carrier medium in computer usable form, which is also envisaged as an aspect of the present invention. For example, the carrier medium may be solid-state memory, optical or magneto-optical memory such as a readable and/or writable disk for example a compact disk and a digital versatile disk, or magnetic memory such as disc or tape, and the computer system can utilise the program to configure it for operation. The computer program may be supplied from a remote source embodied in a carrier medium such as an electronic signal, including radio frequency carrier wave or optical carrier wave.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived therefrom. In particular, with reference to the appended claims, features from dependent claims may be combined with those of the independent claims and features from respective independent claims may be combined in any appropriate manner and not merely in the specific combinations enumerated in the claims.

1. A control device for a domesticated animal, comprising:
a mechanism for producing a sensation disconcerting to a domesticated animal; and
a timer operative to cause said mechanism to produce said disconcerting sensation after a predetermined time period;
said control device being configured such that it may be carried by said domesticated animal without undue interference with said animal's freedom of movement.

2. A control device according to claim 1, releasably attachable to said domesticated animal.

3. A control device according to claim 1 wherein said timer is configurable by a user to set said predetermined time period after which said mechanism is active to produce said disconcerting sensation.

4. A control device according to claim 1, wherein said mechanism produces said disconcerting sensation intermittently.

5. A control device according to claim 1, wherein said timer is configurable by a user to cause said mechanism to produce said disconcerting sensation at predetermined intervals.

6. A control device according to claim 5, wherein said timer is configurable with a second time period to set said predetermined intervals.

7. A control device according to claim 1, wherein said disconcerting sensation comprises a sound audible to an animal.

8. A control device according to claim 7, wherein said sound is audible to a human.

9. A control device according to claim 1, wherein said disconcerting sensation comprises a haptic sensation.

10. A control device according to claim 9, wherein said disconcerting sensation comprises a vibration sensation.

11. A control device according to claim 1, wherein said disconcerting sensation comprises a visual light.

12. A control device according to claim 1, wherein the mechanism is operable to provide variations in said disconcerting sensation.

13. A control device according to claim 1, wherein said mechanism is operable to increase the intensity of said disconcerting sensation over time from said initiation by said timer.

14. A control device according to claim 13, wherein said mechanism is operable to cap said intensity at a predetermined level.

15. A control device according to claim 13, wherein said mechanism is operable to produce said disconcerting sensation for a limited time period.

16. A control device according to claim 15, wherein said timer is configurable by a user to set said limited time period.

17. A control device according to claim 1, further comprising means for releasably attaching the control device to a domesticated animal.

18. A control device according to claim 17, wherein said means for attaching comprises a lanyard for placing around a body part of a domesticated animal.

19. A control device according to claim 18, wherein said lanyard comprises a pouch enclosing said device.

20. A control device according to claim 1, wherein said means for attaching is releasably attachable to a collar or harness.

21. A control device according to claim 1, wherein said device is waterproof.

22. A control device according to claim 1, wherein said device is shockproof.

23. A control device according to claim 22, wherein said device is housed in rugged housing.

24. A control device according to claim 23, wherein said device is housed in a rubberised housing.

25. A collar for a domesticated animal, comprising a control device according to claim 1 integrated therewith.

26. A harness for a domesticated animal, comprising a control device according to claim 1 integrated therewith.

27. A control device according to claim 1, wherein said domesticated animal is a dog.

28. (canceled)

29. (canceled)
